(19) United States
(12) Patent Application Publication
(10) Pub. No.: US 2012/0249417 A1
(43) Pub. Date: Oct. 4, 2012

(54) INPUT APPARATUS

(75) Inventors: Hyeon Joong CHO, Goyang-si (KR); Ju Derk PARK, Daejeon (KR)

(73) Assignee: KOREA UNIVERSITY RESEARCH AND BUSINESS FOUNDATION

(21) Appl. No.: 13/434,341

(22) Filed: Mar. 29, 2012

(30) Foreign Application Priority Data
Mar. 29, 2011 (KR) 10-2011-0027997
Feb. 29, 2012 (KR) 10-2012-0021412

(51) Int. Cl. G09G 5/00

(52) U.S. Cl. 345/156

(57) ABSTRACT

An input apparatus includes a gesture sensing unit for sensing a hand gesture of a user; and an input signal generation unit for generating an input signal for control of a target electronic device based on the sensed hand gesture. The hand gesture of the user includes at least one of a pinching gesture with two or more fingers, a pointing gesture with one finger, and a scratching gesture with one finger to a camera.

### CROSS-REFERENCE TO RELATED APPLICATION

This application claims the benefit of Korean Patent Application No. 10-2011-0027997 filed on Mar. 29, 2011 and Korean Patent Application No. 10-2012-0021412 filed on Feb. 29, 2012, the entire disclosures of which are incorporated herein by reference.

### FIELD OF THE INVENTION

The present disclosure relates to an input apparatus controlling an electronic device based on a hand gesture of a user or a pinching motion with fingers of a user.

### BACKGROUND

With the development of electronic communication technology, operation modes of remote controllers for control of various electronic devices have been diversified. In the case of TV technology that is improving daily, two-way communication between a user and a service provider such as an Internet TV and a smart TV has been promoted. Such TVs cannot be effectively controlled by a conventional button-type remote controller. In order to solve the problem, there have been many attempts to realize an easy and intuitional user interface. One conventional example of the interface is a method that recognizes a gesture of a user thereby determining an intention of the user.

For example, in order to recognize a gesture of the user, a single or stereo camera provided in front of the user may be used. A wearable interface such as a glove or a cloth provided with a sensor may be used. However, using a camera is disadvantageous because the camera is vulnerable to noise, and there is a difficulty in discriminating between a meaningful gesture and a meaningless gesture. The wearable interface is invulnerable to noise. However, wearing the interface is inconvenient and burdensome. If multiple users share the interface, an aversion to wear the interface with an anxiety about the poor cleanness of the interface may occur.

### BRIEF SUMMARY

In order to overcome the above-described problems, the present disclosure provides an input apparatus for controlling a remote screen such as a TV in which the input apparatus is easily gripped with a hand like a conventional remote controller, and a method of recognizing a hand gesture of a user to naturally induce a user interface.

In accordance with an example of an illustrative embodiment, there is provided an input apparatus for sensing a pinching gesture with fingers and generating an input signal for control of various electronic devices based on the pinching gesture.

In accordance with an example of an illustrative embodiment, there is provided an electronic device providing an input interface controlled based on the above-described input apparatus or an interface providing method.

In accordance with an example of an illustrative embodiment, there is provided an input apparatus for sensing various hand gestures of a user and generating an input signal for control of various electronic devices based on the hand gestures.

In order to solve the above-described problems, the input apparatus in accordance with the illustrative embodiment includes: a gesture sensing unit for sensing a hand gesture of a user; and an input signal generation unit for generating an input signal for control of a target electronic device based on the sensed hand gesture, wherein the hand gesture of the user includes at least one of a pinching gesture with two or more fingers, a pointing gesture with one finger, and a scratching gesture with one finger to a camera.

In accordance with the illustrative embodiment, since a pinching gesture with fingers is sensed and used as a control signal of an input interface, an electronic device can be controlled by a simple method. Especially, since the pinching gesture can impress a feeling of actually gripping a virtual layer, a more intuitional interface can be provided to a user.

Since a pinching gesture can be sensed based on variation of a current in a user's fingers, the pinching gesture can be sensed by a simple method. If a movement state of the input apparatus is sensed, in addition to a pinching gesture, various other input signals can be generated.

Furthermore, various hand gestures made by a user can be sensed based on image signals corresponding to the hand gestures of the user. That is, in addition to a pinching gesture, a pointing gesture, a scratching gesture, and combined gestures thereof can be sensed. Since more detailed gestures can be sensed, various other input signals can be generated.

### BRIEF DESCRIPTION OF THE DRAWINGS

Non-limiting and non-exhaustive embodiments will be described in conjunction with the accompanying drawings. Understanding that the accompanying drawings depict only several embodiments in accordance with the present disclosure and are, therefore, not intended to limit the scope of the present disclosure, the present disclosure will be described with specificity and detail through use of the accompanying drawings, in which:

FIG. 1 is an explanatory view of a concept of an input apparatus in accordance with an example of an illustrative embodiment;

FIG. 2 illustrates a configuration of the input apparatus illustrated in FIG. 1;

FIG. 3 illustrates a configuration of a gesture sensing unit in accordance with a first example of an illustrative embodiment;

FIG. 4 is an explanatory view for examples of pinching gestures that can be detected by the input apparatus in accordance with the first example of the illustrative embodiment;

FIG. 5 illustrate a configuration of an electronic apparatus in accordance with an example of an illustrative embodiment;

FIGS. 6A to 6D illustrate interfaces for an input apparatus in accordance with an example of an illustrative embodiment;

FIGS. 7A and 7B illustrate a character input method using an input apparatus in accordance with an example of an illustrative embodiment;

FIG. 8 illustrates a configuration of a gesture sensing unit in accordance with a second example of an illustrative embodiment;

FIGS. 9A to 9D are explanatory views for examples of gestures that can be detected by the input apparatus in accordance with the second example of the illustrative embodiment; and

FIGS. 10A to 10E illustrate examples for a housing of the input apparatus in accordance with the second example of the illustrative embodiment and examples for hand grip positions to grip the housing; and

FIG. 11 illustrates an example for an image signal corresponding to FIG. 10A or 10E.

### DETAILED DESCRIPTION

Hereinafter, illustrative embodiments will be described in detail with reference to the accompanying drawings so that inventive concept may be readily implemented by those skilled in the art. However, it is to be noted that the present disclosure is not limited to the illustrative embodiments but can be realized in various other ways. In the drawings, certain parts not directly relevant to the description are omitted to enhance the clarity of the drawings, and like reference numerals denote like parts throughout the whole document.

Throughout the present disclosure, the terms “connected to” or “coupled to” include both a case where an element is “directly connected or coupled to” another element and a case where an element is “electronically connected or coupled to” another element via still another element. Further, the term “comprises or includes” and/or “comprising or including” used in the document means that one or more other components, processes, operation and/or existence or addition of elements are not excluded in addition to the described components, processes, operation and/or elements.

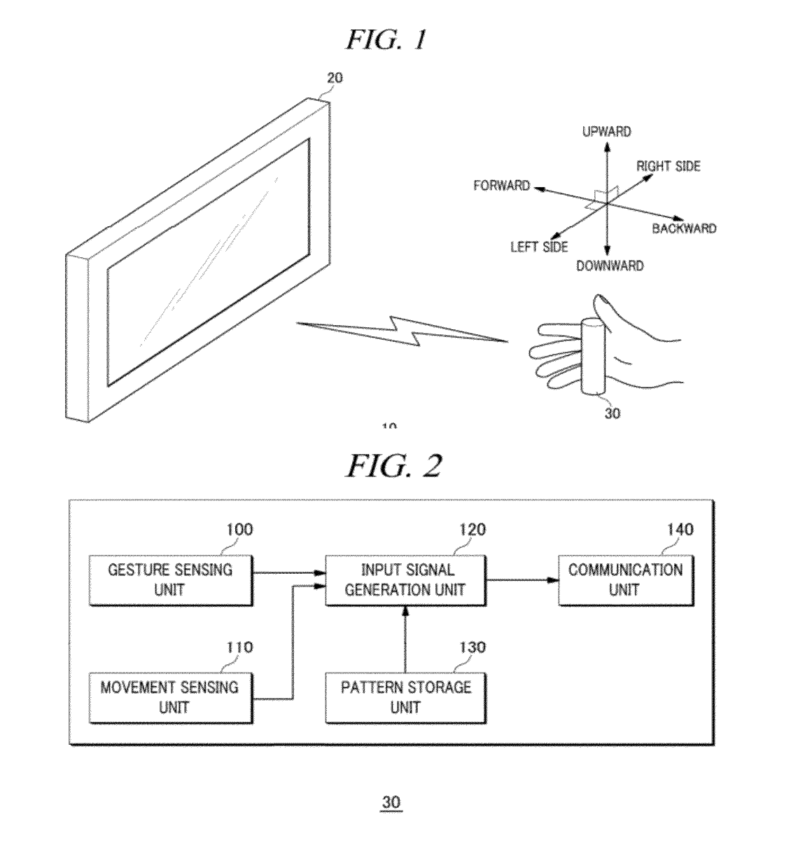

FIG. 1 is an explanatory view for a concept of an input apparatus in accordance with an example of an illustrative embodiment.

A system 10 includes an electronic device 20 and an input apparatus 30.

The electronic device 20 performs various operations based on an input signal received from the input apparatus 30. In this case, the electronic device 20 includes a TV or various display devices that may be controlled by a remote controller.

As the input apparatus 30 is gripped by a hand of a user, the input apparatus 30 senses gestures made by the user, such as an picking-up or pinching gesture by contact of tips of two or more fingers, a scratching gesture with any one of fingers, and a pointing gesture with fingers, so as to generate an input signal for control of the electronic device 20.

The input apparatus 30 transmits the input signal to the electronic device 20 by using infrared ray communication, Bluetooth® communication, or other radio communication methods.

FIG. 2 is a block diagram of the input apparatus illustrated in FIG. 1.

The input apparatus 30 includes a gesture sensing unit 100, a movement sensing unit 110, an input signal generation unit 120, a pattern storage unit 130, and a communication unit 140.

The gesture sensing unit 100 senses a hand gesture of a user for control of the electronic device 20.

In one example, the user may control the electronic device 20 by using a plurality of hand gestures that imply different intentions. In this case, the plurality of hand gestures may include pinching with two or more fingers, pointing by one finger, and scratching by one finger.

The gesture sensing unit 100 in accordance with the first example of the illustrative embodiment senses variation of a current in a user's fingers generated from a pinching gesture by the fingers. For example, as the palm of the user is in contact with an electrode for measurement of a current, tips of two fingers of the user contact each other. The fingers then form a closed circuit so that a current flowing through the hand varies. The gesture sensing unit 100 senses the variation in the current to determine whether a pinching gesture occurs.

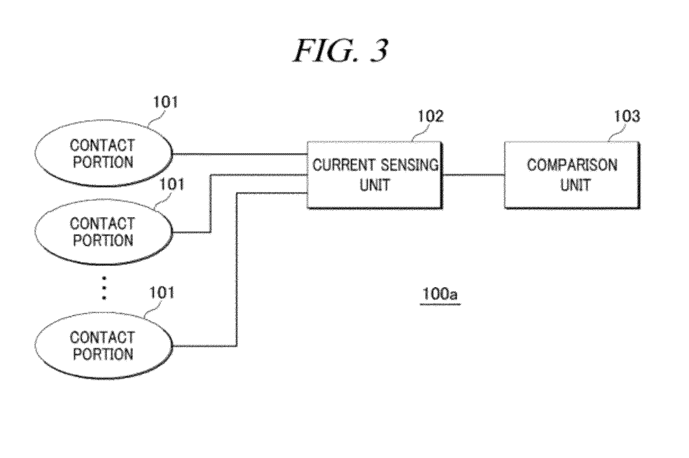

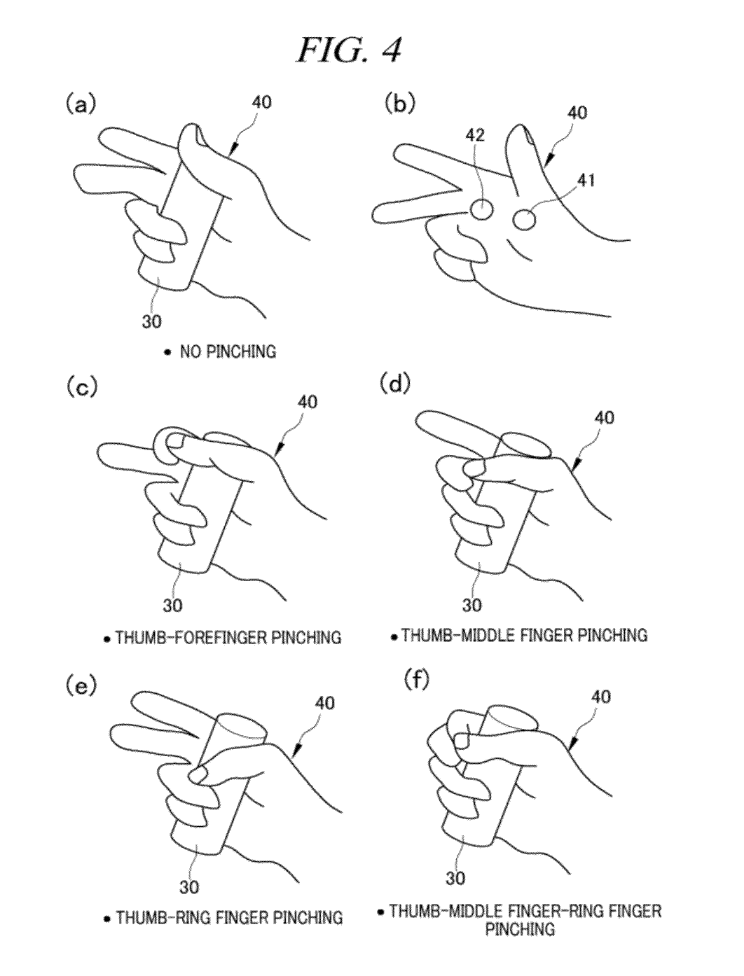

The gesture sensing unit in accordance with the first example will be described in more detail with reference to FIGS. 3 and 4.

FIG. 3 illustrates a configuration of the gesture sensing unit in accordance with the first example of the illustrative embodiment. FIG. 4 is an explanatory view of examples for pinching gestures that can be detected by the input apparatus in accordance with the first example of the illustrative embodiment.

As illustrated in FIG. 3, the gesture sensing unit 100a in accordance with the first example of the illustrative embodiment includes at least one contact portion 101, a current sensing unit 102, and a comparison unit 103.

The at least one contact portion 101 is disposed to be exposed on an external portion of a housing of the input apparatus 30. Here, the contact portion 101 may include an electrode for measurement of a current. A plurality of the contact portions 101 may be provided to sense a plurality of pinching gestures. The number of the contact portions 101 may vary depending on selection by the user.

The current sensing unit 102 receives input of a current flowing in the hand through the contact portion 101 to sense a current value.

The comparison unit 103 compares the current value sensed by the current sensing unit 102 with a reference current value to determine whether a pinching gesture occurs. In this case, it is possible to sense one pinching gesture, among a plurality of different pinching gestures, based on results obtained by comparing the current value sensed by the current sensing unit 102 with a plurality of reference current values.

As illustrated in FIG. 4(a), once a hand 40 of the user grips the input apparatus 30, the hand 40 contacts with the at least one contact portion 101 exposed on the external portion of the housing of the input apparatus 30. In this case, the hand 40 is electrically connected to the current sensing unit 102 through the contact portion 101, so that the current sensing unit 102 measures a current flowing in the hand 40.

The input apparatus 30 may be contained in the housing. Here, the housing has a shape enabling the contact portion 101 exposed on the external portion of the housing to easily contact the skin of the hand 40 of the user when the housing is gripped by the hand 40. For example, the housing may be cylindrical.

When the user performs a pinching gesture by contacting tips of his/her thumb and forefinger (thumb-forefinger pinching), a new electrical signal path is created between the thumb and the forefinger. In this case, as illustrated in FIG. 4(b), a portion 41 where the thumb starts on the palm and a portion 42 where the forefinger starts on the palm contact the contact portion 101. In this way, the signal path created by the thumb and the forefinger electrically connects the two different contact portions. Accordingly, impedance of the hand becomes lower than that prior to performing the thumb-forefinger pinching gesture. Thus, a value for the current flowing in the hand increases.

Since fingers of a hand may vary in length and thickness, a current flowing in the hand may vary depending on which fingers contact each other at the tips thereof. There may be a plurality of pinching gestures, such as a pinching gesture by contact of tips of the thumb and the forefinger (thumb-forefinger pinching) as illustrated in FIG. 4(c), a pinching gesture by contact of tips of the thumb and the middle finger (thumb-middle finger pinching) as illustrated in FIG. 4(d), a pinching gesture by contact of tips of the thumb and the ring finger (thumb-ring finger pinching) as illustrated in FIG. 4(e), and a pinching gesture by contact of tips of the thumb, the middle finger, and the ring finger (thumb-middle finger-ring finger pinching) as illustrated in FIG. 4(f). The pinching gestures can be classified based on current values.

Returning to FIG. 2, the movement sensing unit 110 senses a movement state of the input apparatus 30. As a user grips the input apparatus 30, the user moves the input apparatus 30 in at least one of upward, downward, left, right, forward, and backward directions. In this case, the movement sensing unit 110 senses the movement of the input apparatus 30. For example, the movement sensing unit 110 may use a three-dimensional acceleration sensor to sense the movement, and furthermore, the slope of the input apparatus 30. The movement sensing unit 110 may include a gesture sensor including at least one of a gyroscope, an acceleration sensor, and a geo-magnetic sensor, to sense the movement and the slope of the input apparatus 30.

The input signal generation unit 120 generates an input signal based on a type of pinching gesture received from the gesture sensing unit 100. In this case, the input signal generation unit 120 may generate an input signal, further considering movement state information received from the movement sensing unit 110.

Upon being informed that any one of a plurality of pinching gestures has occurred, the input signal generation unit 120 generates an input signal based on the information. If a pinching gesture and a movement have occurred simultaneously, the input signal generation unit 120 generates an input signal based on the pinching gesture and the movement.

If the movement sensing unit 110 has a gesture sensor including at least one of a gyroscope, an acceleration sensor, and a geo-magnetic sensor, the input signal generation unit 120 receives raw data resulting from sensing by the gesture sensor from the movement sensing unit 110. Based on the raw data, the input signal generation unit 120 estimates three-dimensional x, y, and z axis movement values and position values (pitch, roll, and yaw). In this case, the input signal generation unit 120 may use an estimation algorithm such as the Kalman filter.

In this case, an input signal may be determined based on a pinching gesture and movement state information stored in the pattern storage unit 130. The pattern storage unit 130 stores all possible pinching gestures and all possible movement state information, while matching them with pre-set input signals.

Accordingly, the movement sensing unit 110 compares a pinching gesture and movement state information, which have been input, with values stored in the pattern storage unit 130 to generate an input signal.

The communication unit 140 transmits the input signal received from the input signal generation unit 120 to the electronic device 20. For example, the communication unit 140 transmits the input signal to the electronic device 20 by using infrared ray communication, Bluetooth® communication, and other radio communication methods.

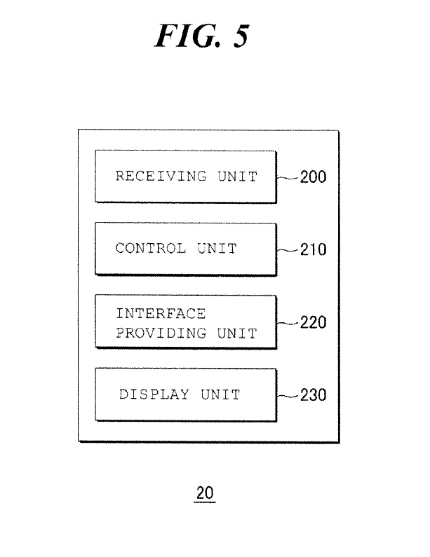

FIG. 5 illustrates configuration of an electronic device in accordance with one example of an illustrative embodiment.

The electronic device 20 includes a receiving unit 200, a control unit 210, an interface providing unit 220, and a display unit 230.

The receiving unit 200 receives the input signal transmitted from the input apparatus 30 and transmits the input signal to the control unit 210 and the interface providing unit 220.

The control unit 210 controls various operations of the electronic device 20 based on the input signal.

The interface providing unit 220 provides various interfaces to display a control state of the electronic device 20 to the user.

The display unit 230 displays the interfaces to the user.

Various interfaces provided by the illustrative embodiment will be described with reference to the drawings.

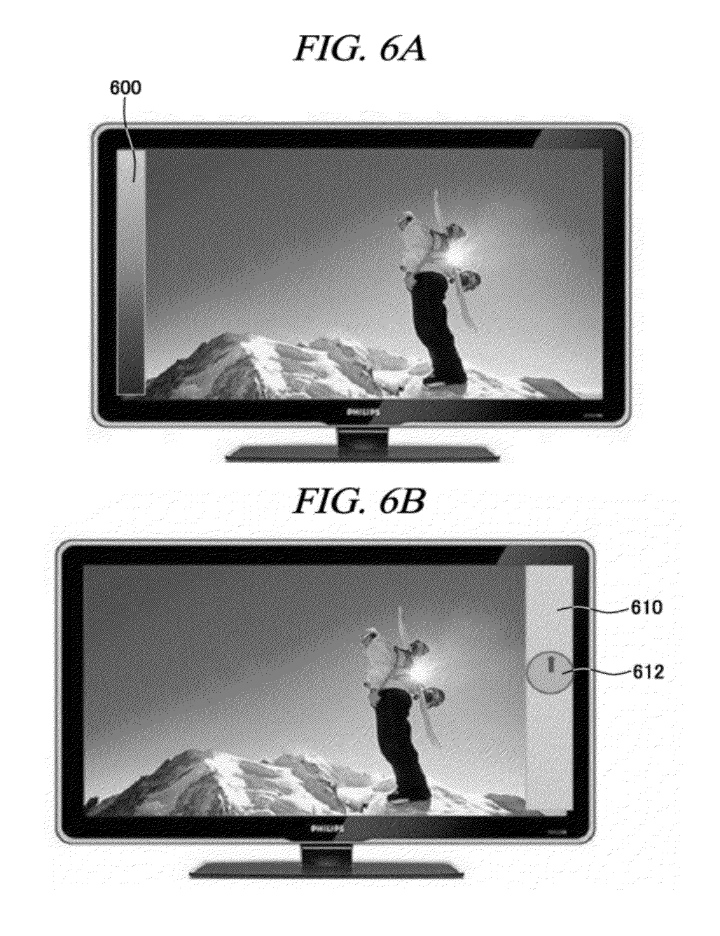

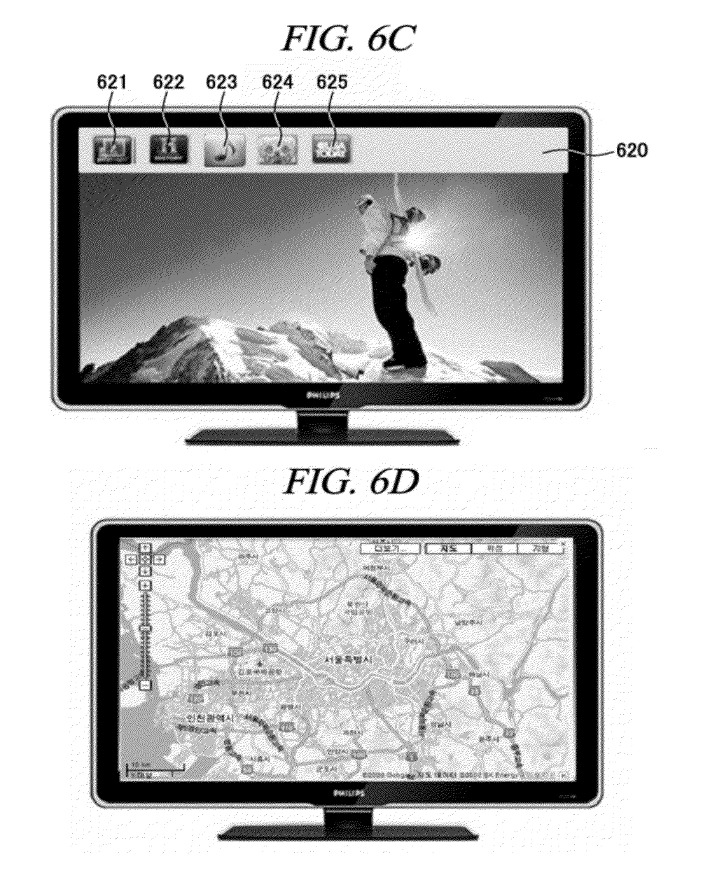

FIGS. 6A to 6D illustrate interfaces for an input apparatus in accordance with an example of an illustrative embodiment.

In FIG. 6A, once the thumb-forefinger pinching gesture is performed, and dragging the input apparatus to a right side is performed, a menu bar 600 is accordingly activated and moved to the right side.

This gesture impresses the same feeling as gripping a virtual layer with his/her thumb and forefinger, and then, dragging the layer to the right side. The gesture can greatly improve intuition to the interface. Thereafter, by performing a gesture of pinching any one point in the menu bar 600, a desired channel or menu is selected.

In FIG. 6B, once the thumb-forefinger pinching gesture is performed, and dragging the input apparatus to a left side is performed, a menu bar 610 is accordingly activated and moved to the left side.

Once the thumb-forefinger-middle finger pinching gesture is performed, a volume control interface 612 is activated, so that the volume may be controlled and adjusted with a spinning gesture by the user.

In FIG. 6C, once the thumb-forefinger pinching gesture is performed, and dragging the input apparatus to an upper side is performed, a menu bar 620 is accordingly activated and moved to the upper side. In other embodiments, the menu bar 620 may be dragged to a lower side, if desired. Various icons 621 to 625 displayed on the menu bar 620 can be selected by pinching gestures.

In FIG. 6D, once the thumb-forefinger pinching gesture is performed, and dragging the input apparatus to a forward or backward side is performed, a screen to be accordingly displayed is controlled for zoom-in or zoom-out. For example, in case of a map service, there are frequent demands for expansion or reduction of a screen. Thus, more convenient and intuitional control can be achieved through the control of the illustrative embodiment.

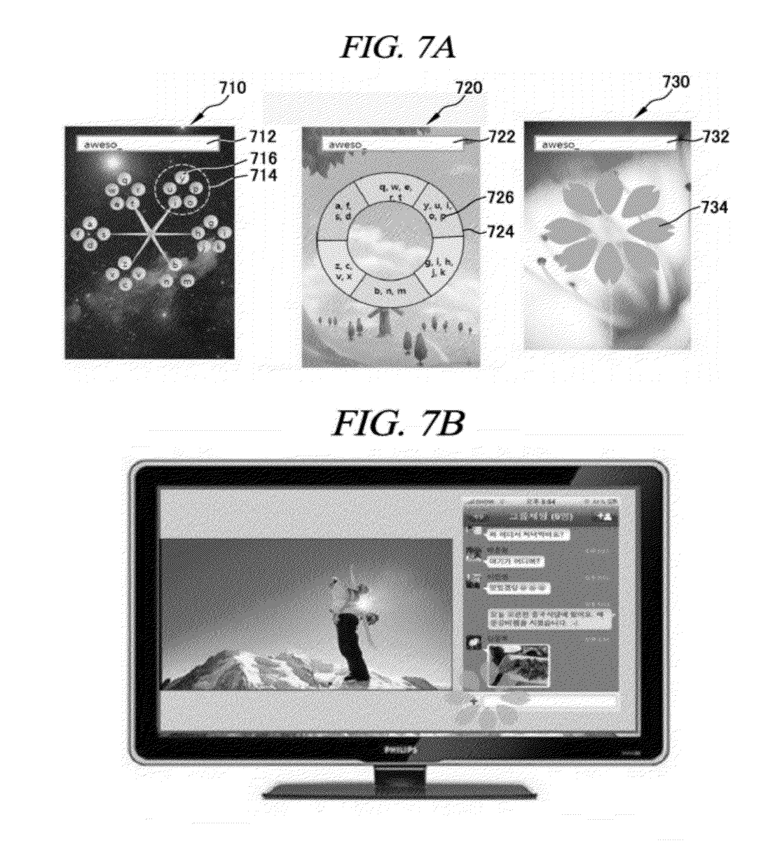

FIGS. 7A and 7B illustrate a method for inputting characters using an input apparatus in accordance with an example of an illustrative embodiment.

As illustrated in FIG. 7A, the interface providing unit 220 provides character input interfaces 710, 720, 730 in various designs.

Although the character input interfaces 710, 720, 730 are different in design, they commonly display character input bars 712, 722, 732 and a plurality of character groups 714, 724, 734.

The character groups 714, 724, 734 include at least one character and are dispersed and displayed on the screen. The user may select a specific character group through a pinching gesture. For example, the user selects a specific character group 714, 724, 734 through a pinching gesture, and then, moves the specific character group to a preset position (a center of the screen) through a dragging gesture. In this case, characters included in the specific character group are dispersed and displayed on preset positions again. For example, the character groups are controlled to not be displayed, and then, the characters therein are dispersed and displayed on the positions where the character groups have been displayed. The user moves any one of the plurality of characters to a preset position through a pinching gesture and a dragging gesture, to thereby set an input character. If the method for inputting a character through a pinching gesture is used, characters can be effectively input while avoiding that the characters are hidden by an input means during the input of the characters.

Through the above-described character input interface, a character chatting program as illustrated in FIG. 7B can be executed in the electronic device 20. For example, if the chatting program is executed in an electronic device such as a smart TV, character inputting can be easily performed through the input apparatus in accordance with the illustrative embodiment.

The gesture sensing unit 100a in accordance with the first example of the illustrative embodiment is electrically connected to the hand of the user through the at least one contact portion 101 in contact with the hand, to thereby measure a value for a current flowing in the hand and determine whether and what hand gesture occurred based on the current value. However, since gestures such as pointing by fingers and scratching with fingers do not generate new nodes or contact portions, the gestures do not cause variation in a value of a current flowing in the hand of the user. Thus, the gesture sensing unit 100a in accordance with the first example may only sense a pinching gesture, and cannot easily sense pointing by fingers, scratching with fingers, and others.

In order to remedy the defect, a gesture sensing unit in accordance with the second example of the illustrative embodiment senses a hand gesture of a user based on an image signal so as to sense pointing by fingers and scratching with fingers, in addition to pinching with fingers.

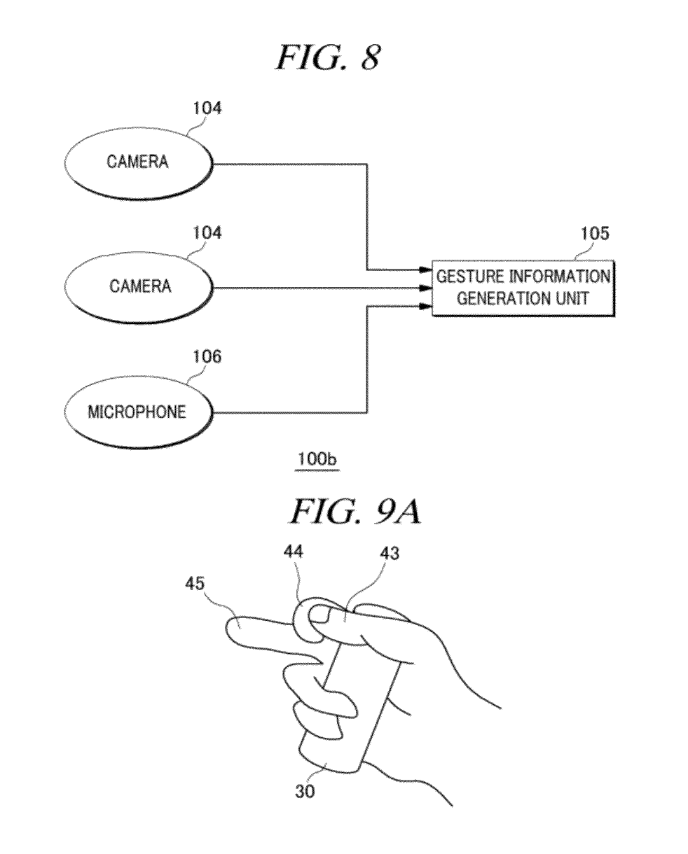

Hereinafter, the gesture sensing unit in accordance with the second example of the illustrative embodiment will be described in more detail with reference to FIGS. 8, 9A to 9E, 10, and 11A to 11D.

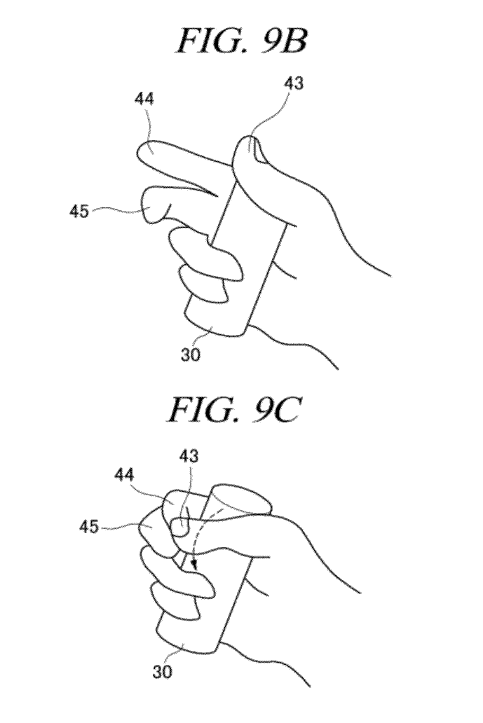

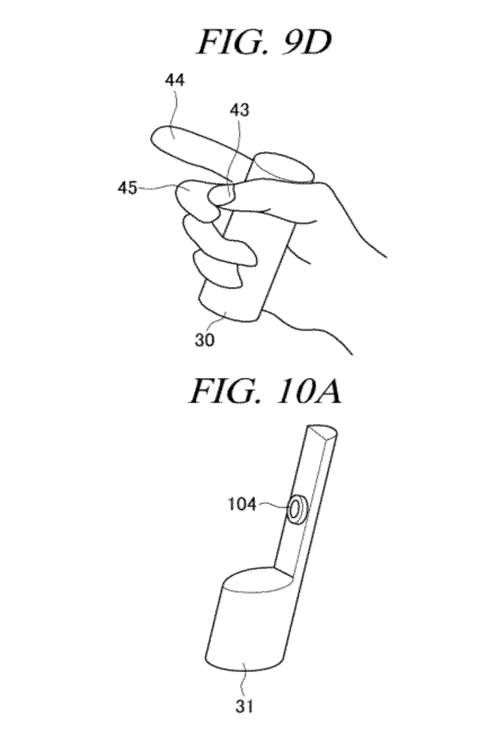

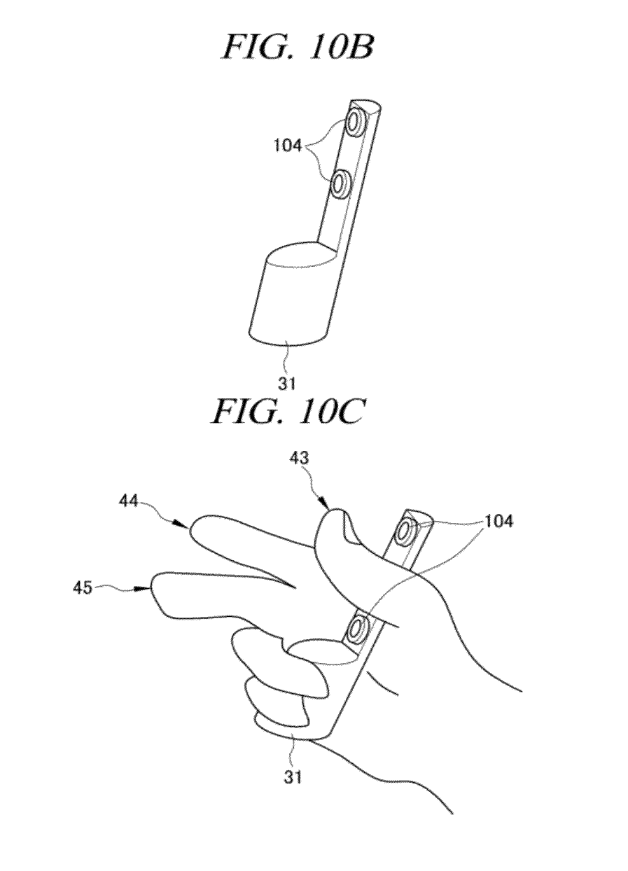

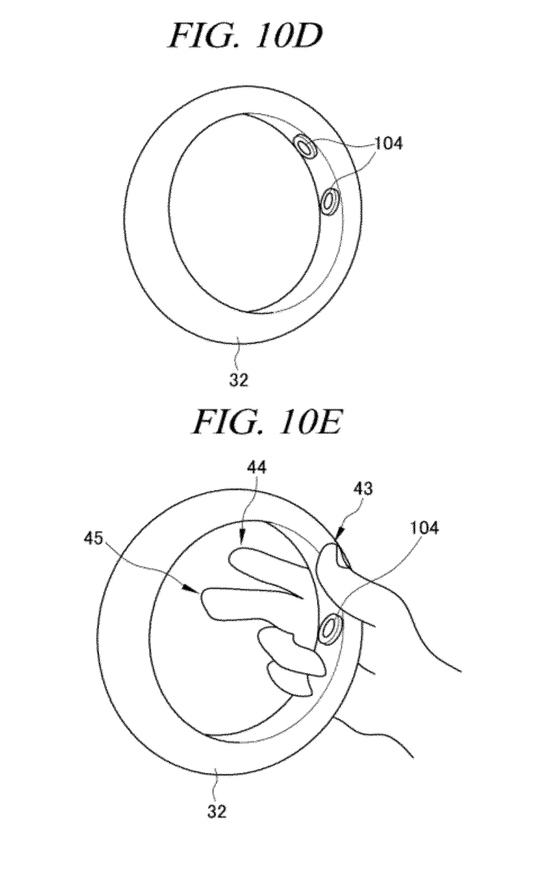

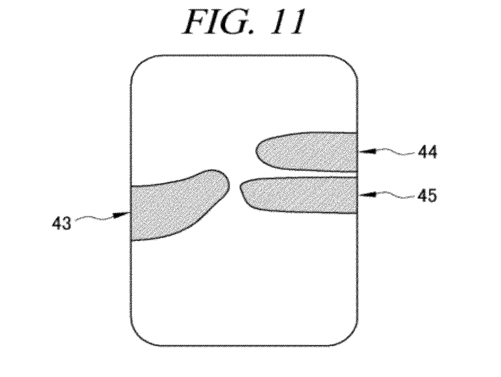

FIG. 8 illustrates a configuration of the gesture sensing unit in accordance with the second example of the illustrative embodiment. FIGS. 9A to 9D are explanatory views of examples for gestures that can be detected by the input apparatus in accordance with the second example of the illustrative embodiment. FIGS. 10A to 10E illustrate an example for the housing of the input apparatus in accordance with the second example of the illustrative embodiment and examples for hand grip positions to grip the housing. FIG. 11 illustrates an example for an image signal corresponding to FIG. 10C or 10E.

As illustrated in FIG. 8, the gesture sensing unit 100b in accordance with the second example of the illustrative embodiment includes at least one camera 104 for generating an image signal corresponding to a hand gesture of a user, and a gesture information generation unit 105 for sensing a hand gesture of a user based on an image signal, generating gesture information corresponding to the sensed hand gesture, and providing the gesture information to the input signal generation unit 120.

The gesture sensing unit 100b may further include at least one microphone 106 for generating an aural signal corresponding to a sound of the moving hand of the user. In this case, the gesture information generation unit 105 may generate gesture information based on the image signal and the aural signal.

The camera 104 is disposed on the external portion of the housing containing the input apparatus 30. The camera 104 captures a hand gesture of a user in the state that the housing is gripped, and generates an image signal. Here, in order to capture a hand gesture of the user in the state that the housing of the input apparatus 30 is gripped, the camera 104 may be disposed at a portion corresponding to a finger of the user on the housing of the input apparatus 30.

Although one camera 104 may be provided, the illustrative embodiment is not limited thereto. Two or more cameras 104 may be provided while being spaced from each other in order to capture images in various directions. The number of the cameras 104 may vary depending on selection by the user.

The gesture sensing unit 100b may further include an infrared ray emission unit (not illustrated) for radiating a light to the hand of the user. In this case, the camera 104 further includes an infrared ray filter to prevent errors caused by the infrared ray emission unit (not illustrated). In this way, the input apparatus 30 can be used even in case of low illuminance of an external light.

The microphone 106 is disposed adjacent to the hand of the user. The microphone 106 senses a sound generated from friction of the bone or the skin of the moving hand, and generates an aural signal corresponding to the sound. The microphone 106 may be provided on the external portion of the housing containing the input apparatus 30 as a separate instrument or a component of the camera 104. By using the microphone 106, movement of the hand can be more clearly sensed, thereby improving accuracy of the apparatus.

Based on the image signal generated by the camera 104, the gesture information generation unit 105 senses a hand gesture corresponding to the image signal among a plurality of hand gestures.

In this case, the gesture information generation unit 105 processes the image signal input from the camera 104, thereby sensing a hand gesture corresponding to the image signal.

If the image signal by the camera 104 is a color image, the gesture information generation unit 105 may process the input image signal by performing, for the image signal, processes such as noise removal using an average filter, finger area extraction using a color filter, morphology calculation, extraction of characteristic points such as fingertips, and sensing a hand gesture through image analysis.

If the image signal by the camera 104 is a color image, the gesture information generation unit 105 may process the input image signal by performing, for the image signal, processes such as noise removal using an average filter, binarization, morphology calculation, labeling, contour extraction, extraction of characteristic points such as fingertips, and sensing a hand gesture through image analysis.

If the image signal by the camera 104 is an infrared ray image, the gesture information generation unit 105 may process the input image signal by performing, for the image signal, processes such as noise removal using an average filter, edge detection, morphology calculation, contour extraction, extraction of characteristic points such as fingertips, and sensing a hand gesture through image analysis.

Here, the morphology calculation means removing noise from the image signal through calculation of expansion, erosion, and others.

Based on the image signal and the aural signal, the gesture information generation unit 105 may sense a hand gesture corresponding to the image signal among a plurality of hand gestures.

With reference to FIGS. 9A to 9D, the plurality of hand gestures may include a pinching gesture with two or more fingers, a pointing gesture with one finger, a scratching gesture by one finger to the camera 104, and a combined gesture of pinching with two fingers and pointing with another finger.

As illustrated in FIG. 9A, the pinching gesture with two or more fingers is a gesture by contact of two or more fingers. FIG. 9A only illustrates the thumb-forefinger pinching gesture by contact of the thumb 43 and the forefinger 44. However, as illustrated in FIG. 4, the pinching gesture may include the thumb-middle finger pinching gesture, the thumb-ring finger pinching gesture, and the thumb-middle-ring finger pinching gesture.

As illustrated in FIG. 9B, the pointing gesture with one finger involves stretching any one of the fingers while pointing in one direction. FIG. 9B only illustrates that the forefinger 44 is straight, and stretched forward such that none of the thumb 43, the forefinger 44, and the middle finger 45 is used for a pinching gesture. In other examples, the pointing gesture may include a pointing gesture with the thumb 43 or the middle finger 45.

As illustrated in FIG. 9C, the scratching gesture with one finger is a gesture of moving any one of the fingers in one direction while touching the camera 104. The scratching gesture with one finger may be a gesture that one finger touches the tips of another finger. For example, the scratching gesture with one finger may be a gesture that the thumb 43 moves upwardly and downwardly while touching the tips of the forefinger 44 and the middle finger 45. Although FIG. 9C only illustrates a scratching gesture with the thumb 43, the scratching gesture may further include a scratching gesture with the forefinger 44 or a scratching gesture with the middle finger 45.

As illustrated in FIG. 9D, the combined gesture is a gesture that a pointing gesture or a scratching gesture is performed simultaneously with a pinching gesture. Although FIG. 9D only illustrates a combined gesture of a pinching gesture with the thumb 43 and the middle finger 45 and a pointing gesture with the forefinger 44, the combined gesture may include other combinations of gestures.

A gesture of moving the input apparatus 30 in upward, downward, right, and left directions together with a pinching gesture may mean a command to drag an object to the corresponding direction. A gesture of moving the input apparatus 30 in a forward and backward direction together with a pinching gesture may mean a command to expand or reduce an object. A gesture of moving the input apparatus together with a pointing gesture with the forefinger may mean a command to move a mouse cursor. A gesture of scratching in a downward and upward direction may mean a command for scroll-down and scroll-up. A gesture of moving the input apparatus 30 in upward, downward, right, and left directions together with a combined gesture of a pinching gesture and a pointing gesture may mean a command to drag an object along with the cursor.

However, the meanings of the gestures are merely illustrative. The gestures may be matched with other meanings according to selection by the user.

Referring back to FIG. 8, the gesture information generation unit 105 is capable of sensing a hand gesture corresponding to an image signal, further based on a plurality of image reference values corresponding to a plurality of hand gestures. That is, the gesture information generation unit 105 compares an image signal periodically input from each of the cameras 104 with a plurality of image reference values corresponding to a plurality of hand gestures, and detects one of the image reference values within a certain error range for a difference from the image signal. The gesture information generation unit 105 senses that the hand gesture of the detected image reference value corresponds to the image signal.

As one example in this regard, the gesture information generation unit 105 compares an input image signal and an image reference value corresponding to the thumb-forefinger pinching gesture. If an error between the input image signal and the image reference value is within an allowable range, the gesture information generation unit 105 can sense the thumb-forefinger pinching gesture.

The gesture information generation unit 105 may sense a hand gesture of a user corresponding to an image signal, based on variation of an image signal periodically input from each of the cameras 104.

Exemplarily, if variation of an image signal is insignificant, the gesture information generation unit 105 compares the current image signal with the previous image signal. If the difference between the current image signal and the previous image signal is within an allowable range, the gesture information generation unit 105 senses that the hand gesture of the user is maintained.

The input apparatus in accordance with the second example of the illustrative embodiment may be contained in a cylindrical housing, as in the first example. However, as the input apparatus of the second example includes a gesture sensing unit 100b equipped with the cameras 104 or the cameras 104 and the microphone 106, the input apparatus of the second example may be contained in a cylindrical housing transformed to arrange the cameras 104 therein.

As illustrated in FIGS. 10A to 10C, the housing 31 of the input apparatus may be in a transformed cylindrical shape having a part in a cylindrical shape and the other part in a semi-cylindrical shape.

In this case, as illustrated in FIG. 10A, one camera 104 may be provided in the semi-cylindrical part of the housing 31. As illustrated in FIG. 10B, two cameras 104 may be provided in the semi-cylindrical part of the housing 31 while being spaced from each other in an upward and downward direction.

In this case, as illustrated in FIG. 10C, the user grips the cylindrical part of the housing 31, by using his/her ring finger, little finger, and palm. In this state, the user may express a gesture by changing a hand gesture using his/her thumb 43, forefinger 44, and middle finger 45.

As illustrated in FIGS. 10D and 10E, the housing 32 of the input apparatus may be in a ring shape. In this case, the cameras 104 are provided in the inner surface of the ring-shaped housing 32.

As illustrated in FIGS. 10C and 10E, the cameras 104 provided in the semi-cylindrical part of the transformed cylindrical housing 31 or in the inner surface of the ring-shaped housing 32 can generate an image signal like FIG. 11 in correspondence with a hand gesture in the state that the housing 31, 32 is gripped.

For reference, each of components illustrated in FIG. 2 in accordance with the embodiment of the present invention may imply software or hardware such as a field programmable gate array (FPGA) or an application specific integrated circuit (ASIC), and they carry out a predetermined function.

However, the components are not limited to the software or the hardware, and each of the components may be stored in an addressable storage medium or may be configured to implement one or more processors.

Accordingly, the components may include, for example, software, object-oriented software, classes, tasks, processes, functions, attributes, procedures, sub-routines, segments of program codes, drivers, firmware, micro codes, circuits, data, database, data structures, tables, arrays, variables and the like.

The components and functions thereof can be combined with each other or can be divided.

The illustrative embodiments can be embodied in a storage medium including instruction codes executable by a computer or processor such as a program module executed by the computer or processor. A data structure in accordance with the illustrative embodiments can be stored in the storage medium executable by the computer or processor. A computer readable medium can be any usable medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The apparatus and the system of the illustrative embodiments have been described in relation to certain examples. However, components or parts or all the operations of the apparatus and the system may be embodied using a computer system having universally used hardware architecture.

The above description of the illustrative embodiments is provided for the purpose of illustration, and it would be understood by those skilled in the art that various changes and modifications may be made without changing technical conception and essential features of the illustrative embodiments. Thus, it is clear that the above-described illustrative embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept.

### [Explanation of Codes]

10: system
20: electronic device
30: input apparatus
40: hand of a user
43, 44, 45: thumb, forefinger, and middle finger of a hand
100, 100a, 100b: gesture sensing unit
110: movement sensing unit
120: input signal generation unit
130: pattern storage unit
140: communication unit
101: contact portions
102: current sensing unit
103: comparison unit
200: receiving unit
210: control unit
220: interface providing unit
230: display unit
104: camera
105: gesture information generation unit
106: microphone
31, 32: housing of an input apparatus

What is claimed is:

1. An input apparatus comprising:
a gesture sensing unit sensing a hand gesture of a user; and
an input signal generation unit for generating an input signal for control of a target electronic device based on the sensed hand gesture,
wherein the hand gesture of the user includes at least one of a pinching gesture with two or more fingers, a pointing gesture with one finger, and a scratching gesture with one finger to camera.

2. The input apparatus of claim 1,
wherein the input apparatus further comprises a communication unit for transmitting the generated input signal to the target electronic device.

3. The input apparatus of claim 1,
wherein the gesture sensing unit senses the pinching gesture based on variation of a current flowing in the hand of the user.

4. The input apparatus of claim 1,
wherein the gesture sensing unit comprises:
at least one contact portion contacting the skin of the hand of the user;
a current sensing unit connected to the contact portion to sense a current; and
a comparison unit for sensing the pinching gesture based on a current value sensed through the current sensing unit.

5. The input apparatus of claim 4,
wherein the comparison unit compares the current value sensed through the current sensing unit with a plurality of reference current values to sense one of a plurality of pinching gestures, and
the plurality of pinching gestures include a pinching gesture with two of five fingers.

6. The input apparatus of claim 4,
wherein the input apparatus further comprises a housing containing the input apparatus,
the contact portion is connected to an external portion of the housing, and
when the housing is gripped by the hand of the user, the contact portion is in contact with the skin of the hand of the user.

7. The input apparatus of claim 1
wherein the gesture sensing unit comprises:
at least one camera for generating an image signal corresponding to the hand gesture of the user; and
a gesture information generation unit for sensing the hand gesture of the user based on the image signal, generating gesture information corresponding to the sensed hand gesture, and providing the gesture information to the input signal generation unit.

8. The input apparatus of claim 7,
wherein the gesture information generation unit senses the hand gesture of the user, further based on a plurality of image reference values corresponding to the plurality of hand gestures.

9. The input apparatus of claim 7,
wherein the input apparatus further comprises a housing containing the input apparatus, and
the camera captures an external portion of the housing to generate the image signal.

10. The input apparatus of claim 1,
wherein the input apparatus further comprises a movement sensing unit for sensing a movement state of the input apparatus, and
the input signal generation unit generates the input signal, further based on the movement state.

11. The input apparatus of claim 10,
wherein the input apparatus further comprises a pattern storage unit for matching the hand gesture of the user and the movement state with the input signal and storing the hand gesture of the user and the movement state therein, and
the input signal generation unit generates an input signal based on information stored in the pattern storage unit.

12. An electronic device controlled based on an input signal generated in the input apparatus of claim 1.

13. The electronic device of claim 12,
wherein the electronic device comprises:
a receiving unit for receiving the input signal;
a control unit for controlling the electronic device based on the input signal;
an interface providing unit for providing an interface to display a control state of the electronic device based on the input signal to the user; and
a display unit for displaying the interface to the user.

14. The electronic device of claim 13,
wherein in the interface providing unit,
a menu bar is activated by the hand gesture of the user, and
the menu bar is moved in one of upward, downward, right, left, forward, and backward directions on the display unit depending on the hand gesture of the user and the movement state of the input apparatus.

15. The electronic device of claim 13,
wherein in the interface providing unit,
a character selection menu displaying a plurality of character groups each containing at least one character is activated by the hand gesture of the user, and
one of the plurality of character groups is selected depending on the hand gesture of the user and the movement state of the input apparatus, and one of characters contained in the selected character group is selected to be set as an input character.

16. An interface providing method comprising:
(a) receiving an input signal generated in an input apparatus; and
(b) providing an interface for displaying a control state of an electronic device based on the input signal to a user,
wherein the input signal is generated by sensing variation of a current in a hand of the user or an image signal corresponding to a hand gesture of the user, and
the hand gesture of the user includes at least one of a pinching gesture with two or more fingers of the hand of the user, a pointing gesture with one finger of the hand of the user, and a scratching gesture with one finger of the hand of the user to a camera.

17. The interface providing method of claim 16,
wherein the input signal is generated, further considering the movement state of the input apparatus.

18. The interface providing method of claim 16,
wherein step (b) further comprises:
activating a menu bar on the interface of the electronic device depending on the hand gesture of the user included in the input signal; and
moving the menu bar in one of upward, downward, right, left, forward, and backward directions depending on the hand gesture of the user included in the input signal and the movement state of the input apparatus.

19. The interface providing method of 16,
wherein step (b) further comprises:
activating a character selection menu for displaying a plurality of character groups each containing at least one character on the interface of the electronic device, depending on the hand gesture of the user included in the input signal; and
selecting one of the plurality of character groups depending on the hand gesture of the user included in the input signal and the movement state of the input apparatus, and selecting one of characters contained in the selected character group to be set as an input character.
